(19) United States
(12) Patent Application Publication
(10) Pub. No.: US 2015/0203120 A1
(43) Pub. Date: Jul. 23, 2015

(54) VEHICLE WITH AN ELECTRIC ENERGY CONSUMPTION PREDICTION MODULE

(71) Applicants: Yung-Chi LIANG, Bade City (TW); Kuo-Ching CHIANG, New Taipei City (TW)

(72) Inventors: Yung-Chi LIANG, Bade City (TW); Kuo-Ching CHIANG, New Taipei City (TW)

(21) Appl. No.: 14/159,453

(22) Filed: Jan. 21, 2014

(51) Int. Cl. B60W 40/06; B60W 40/12

(52) U.S. Cl. CPC B60W 40/06; B60W 40/12; B60W 2510/244; B60W 2550/147

(57) ABSTRACT

A vehicle includes a control system and an electric energy battery system coupled to the control system; an electric energy consumption prediction module is coupled to the control system; a gyro is coupled to the control system to detect a road condition, and transmitted the detected road condition to the control system; wherein the electric energy consumption prediction module is in responsive to the detected road condition to generate a predict information for predicting a remaining travel distance of said vehicle.

### TECHNICAL FIELD

The present invention relates generally to a portable terminal and more particularly to a portable terminal with inert navigator.

### BACKGROUND OF THE RELATED ART

Well known in the art is an automotive data system for collecting data from a vehicle, a way to calculate the energy consumption of engine is to measure the fuel consumption during the operation period of the vehicle. U.S. Pat. No. 8,589,002 disclosed a methods and systems for estimating engine fuel consumption. The method comprises controlling an engine according to a control map, the control map specifying control settings according to a predetermined relationship with respect to engine speed and engine load. The remaining vehicle travel distance is crucial information to the driver. However, those known systems failed to consider the road conditions.

### SUMMARY

The object of the present invention is to provide the electric energy prediction for an electricity vehicle. The present invention is provided for a battery electric vehicle (BEV) or hybrid vehicle. A battery electric vehicle (BEV) is a type of electric vehicle (EV) that uses chemical energy stored in rechargeable battery packs. As will be discussed in detail below, the present invention discloses a system and method that provides the driver of an electric vehicle with the estimated distance remaining that the vehicle is capable of traveling.

A vehicle includes a control system and an electricity energy battery system coupled to the control system; an electric energy consumption prediction module is coupled to the control system; a gyro is coupled to the control system to detect a roll condition, and transmitted the detected road condition to the control system; wherein the electricity energy consumption prediction module is in responsive to the detected road condition to generate a predict information for predicting a remaining travel distance of the vehicle by using the residual electric energy. A consumption database is coupled to the electric energy consumption prediction module. A relationship is set between a road condition and the electric energy consumption. The predicted information is displayed on a display, or/and the predicted information is transmitted to a speaker.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows a diagram of a portable terminal according to the present invention.

FIG. 2 shows a diagram of a portable terminal according to the present invention.

FIG. 3 shows a diagram of a portable terminal according to the present invention.

FIG. 4 shows a diagram of a portable terminal according to the present invention.

FIG. 5 shows a diagram according to the present invention.

### DETAILED DESCRIPTION

The following description relates to various embodiments of methods and systems for estimating fuel consumption of an engine. In one example, a method comprises controlling an engine according to a control map, the control map specifying control settings according to a predetermined relationship with respect to engine speed and engine load. The method further comprises estimating fuel consumption of the engine based on an electric-machine-based engine load indicated by an electric machine coupled to the engine and further based on the predetermined relationship. Controlling the engine may include determining a fuel injection amount based on the engine speed and load according to the predetermined relationship, for example. The present invention relates to a portable communication device with inert navigator and calculator. The portable device according to the present invention includes but not limited to cellular, PDA (personal digital assistant), smart phone, note book, tablet and digital camera and the equivalent thereof.

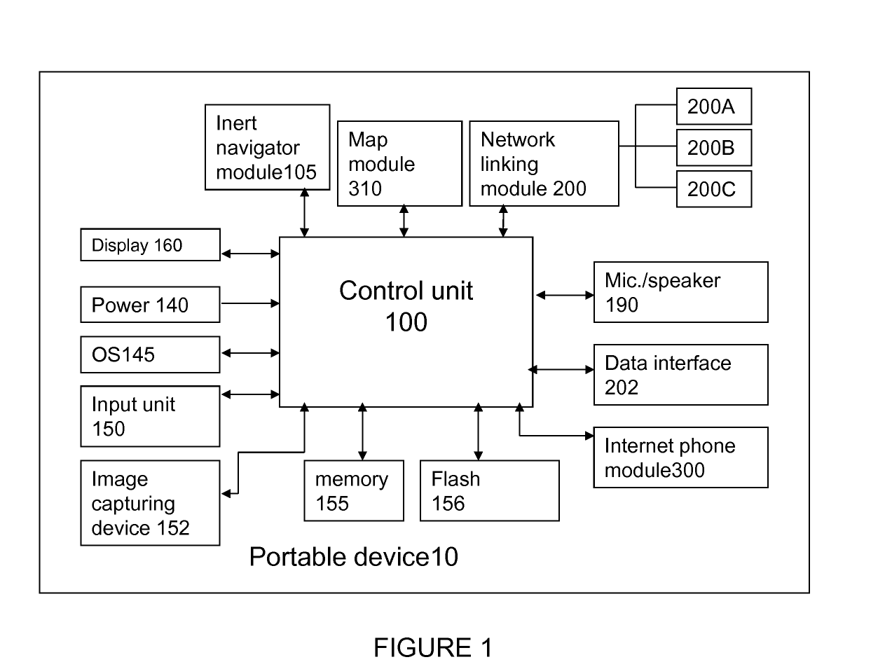

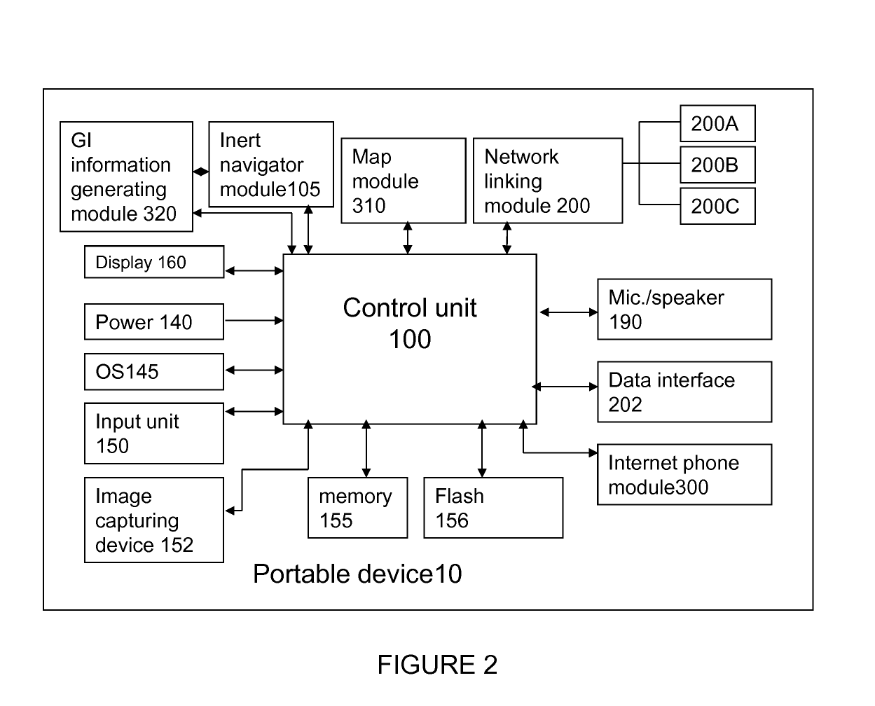

FIG. 1 and FIG. 2 show a block diagram of a portable communication device having processor 100, an inert navigator module 105 coupled to the processor 100. The inert navigator module 105 is gyro, G-sensor or accelerator. The type of the inert navigator module 105 includes mechanical type, MEMS or fiber type navigator. The inert navigator module 105 may define the location without reception of the satellite signals, therefore, the present invention may navigate even in the base room, underground or tunnel. The inert navigator module 105 includes geography interpreter or look-up table to interpret the geography information detected by the inert navigator module 105. The geography information interpreted by the inert navigator module 105 can be displayed on the display of the device. The system 100 includes input unit 150, display 160, OS 145, an image capturing device 152, and power source 140. The OS 145 maybe any type of the mobile phone OS, for instance, android, MS, Apple OS. An electronic map module 310 is stored in the memory or a remote server. The inert navigator module 105 is processed with the electronic map module 310 and may indentify the geography information (such as longitude and latitude) or locating the location of the current portable communication device location on the map.

As know in the art, the RF signal transmission module includes antenna. This antenna 105 is connected to a transceiver, which is used to receive and transmit signal. AS know, the RF module further includes MODEN, CODEC, DSP and A/D converter as well. Due to the RF module is not the feature of the present invention, therefore, the detailed description is omitted. The present invention includes a central control IC, an input unit, a build-in display, OS, power and memory including a ROM program memory, a RAM memory. All of the components are coupled to the Control IC. Nonvolatile FLASH memory is coupled to the control IC. The RF module may perform the function of signal transmitting and receiving, frequency synthesizing, base-band processing and digital signal processing. The SIM card hardware interface is used for receiving a SIM card. Finally, the signal is send to the final actuators, i.e. a loudspeaker and a microphone 190.

A data exchange interface 200 is provided and coupled to the control IC 100. The data exchange interface 200 is capable of coupling to the I/O port of a computer system, directly or indirectly. The data exchange interface 200 provides the interface for exchanging the information between the portable device and the computer system. At current, the conventional cell-phone is incapable communicated with the computer system by its built-in unit. The data exchange interface 200 is preferred a USB (universal serial bus) interface or Fire Wire interface or the IEEE 1394. The USB or the Fire Wire 200 is provided and coupled to the control IC 100. Through the USB interface or the Fire Wire 200, the user may transmit the data such as E-mail, MP3 file, image file (taken by the image capturing unit 152) or downloaded data to the computer. Alternatively, the portable device 10 may update information such as OS, program or the like from the computer system

The data exchange interface 200 may includes wireless internet network exchange interface 200A, wireless metropolis network exchange interface 200B, or mobile phone network 200C, such as 3G, 4G or higher standard. The data exchange interface 200 may download or update the electronic map or weather, traffic, gas station information. A part of the USB or the Fire Wire interface 200 maybe extended outside the housing of the flash drive-like cellular. The inner end of the interface 200 fastened into the inside of the housing. The aforementioned USB interface 200 could be A-type USB interface with a flat and wide shape, or B-type USB interface with a rectangular shape or a Mini-type USB interface with a flat and narrow shape. The definition of USB type may refer to US Patent Application No. 20040038592, entitled “USB flash drive”. The flash memory could be replaced by other NVM (non-volatile memory) such as NROM (nitride-ROM), SONOS or MRAM, FRAM. The present HPC may function as memory drive. The memory drive refers to a commercial memory device with USB interface such as flash drive. The flash memory 156 can be coupled to the USB or the Fire Wire ports of personal computer, digital camera, etc. by means of the Fire Wire or USB interface 200. For the digital camera user, the capacity of the camera's memory card is small. The user has to change the memory card, frequently. One aspect of the present invention is that the digital camera or digital video camera may couple to the flash drive like cellular, thereby transferring the data or the image file to the flash memory 156 of the portable device through the USB interface 200. Further, the present invention also includes a wireless transmission unit for short distance transmission between the cellular and a computer. A VoIP phone module 300 is coupled to the processor 100 for allow the user to call internetwork phone through the interface 200, for instance, Wi-Fi or WiMAX (Worldwide Interoperability for Microwave Access).

Currently, the mass traffic system, vehicle or transporter employs GPS as the location pointing, however, the monitor center may only know the location on the map, nothing else, the present invention provide a method to monitor the vehicle. The vehicle includes INS module 105 set in the vehicle to fetch the geography information (such as longitude and latitude) and the information is merged within the image captured by the image capturing device set inside or outside of the vehicle. The transmitter may transmit the video image with the geography information (such as longitude and latitude) to the monitor center, therefore, the monitor center may receive the video with longitude and latitude to judge where the event occurred. The wireless transmitter includes WiFi, WiMax, 3G, 3,5G or 4G. The image capturing device includes digital still camera or digital video camera.

Further, a vibration threshold maybe set in the controller, when the vibration of the gyroscope is over the threshold, or the vibration is continuous to a time interval, or the gyro detect the vehicle is moved to a distance when the security system with the gyro is on duty. The security system coupled to the control IC issues alarm signal which refers to illegal event, such as steal, impact, intrude. The transmitter coupled to the control IC may transmit the captured image to the monitor center. The object may be vehicle, cellular, tablet. Therefore, the system may monitor the object with longitude and latitude information.

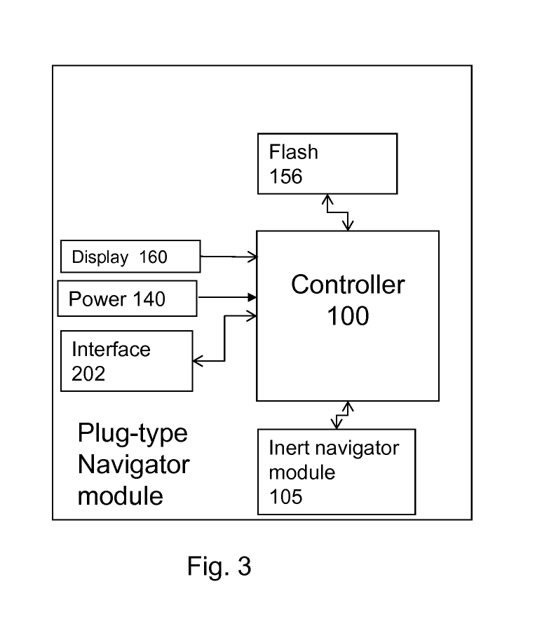

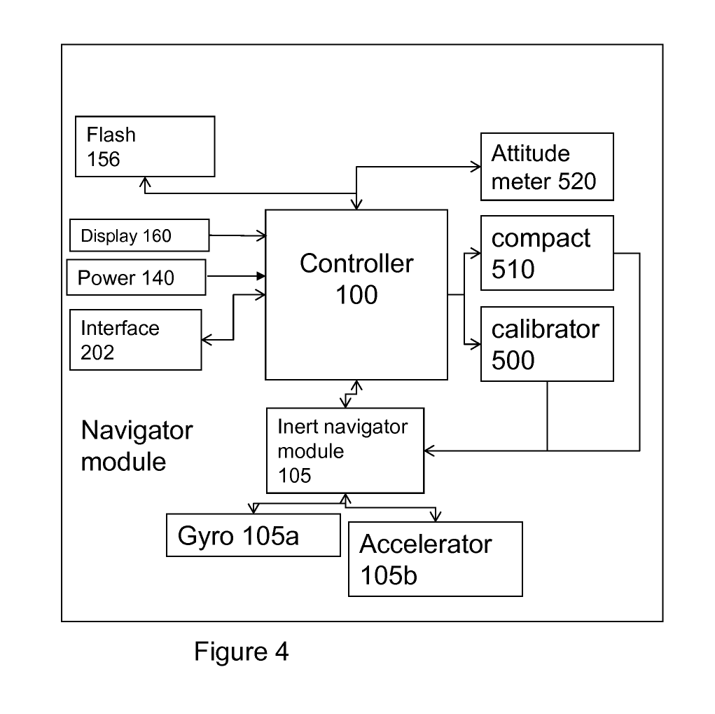

FIG. 3 and FIG. 4 show anther embodiments of the present invention, most of the elements are similar with above example. The embodiment further includes calibrator 500 coupled to the inert navigator module 105 to calibrate the accumulative errors of the inert navigator module 105. The inert navigator module 105 could be gyro 105a or accelerator 105b or the combination. The inert navigator module 105 maybe one axis, dual axis or triple axis, The accelerator 105b maybe one axis, dual axis or triple axis. The errors of the inert navigator module 105 or a magnetic compass 510 maybe accumulated, the present invention includes calibrator 500 coupled to the inert navigator module 105 or a magnetic compass 510 to correct the errors. The gyro 105a or accelerator 105b may be employed to fetch the geography and motion information such as direction, calibrator 500 may correct the error of the gyro 105a by fetching the satellite information. In one case, when the mobile device is switched on, the calibrator 500 is responsive the signal to calibrate or correct the initial conditions of the gyro 105a by receiving the satellite information with geography data to calibrate the gyro 105a. The device maybe set to calibrate the gyro 105a by time. The calibrator 500 maybe GPS, when the gyro or the magnetic compass is calibrated, the GPS is off to save the power due to the inert navigator module 105 or the magnetic compass 510 may be operated without electrical power. Further, the current arrangement may allow the mobile device be operation without the reception of the satellite signals and omit or reduce the kalman filters to save the resources. The attitude meter 520 is coupled to the control IC to distinguish whether the vehicle is on the ground or on the overpass way, the traditional GPS cannot tell the difference between both situations, which may cause the miss navigating.

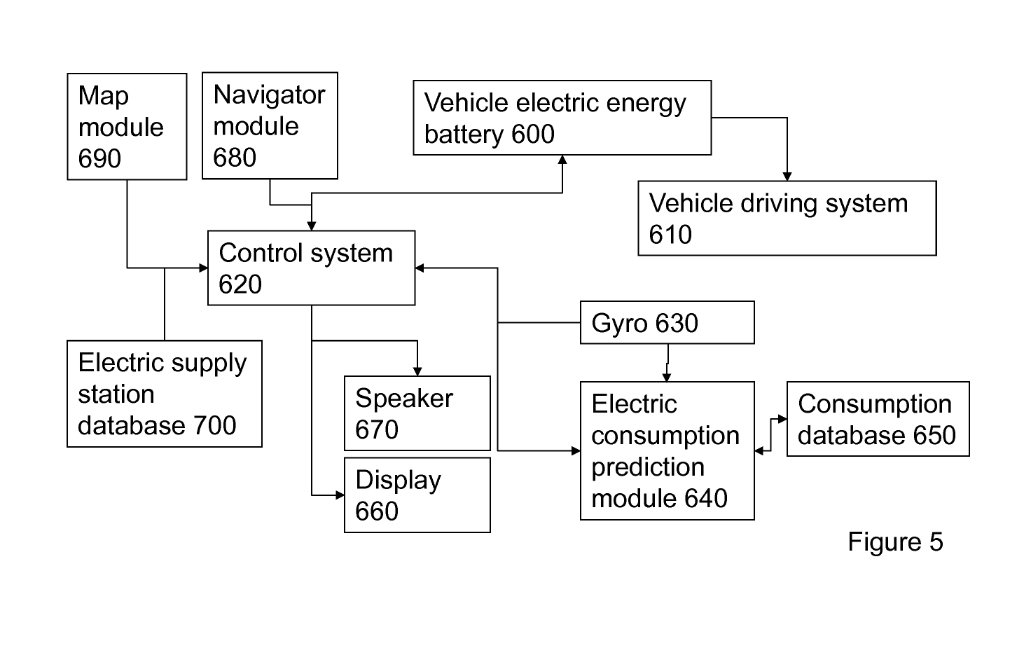

A battery electric vehicle is a type of electric vehicle that uses chemical energy stored in rechargeable battery packs. The above features may be incorporated into the following embodiment. The battery electric vehicle uses electric motors and motor controllers instead of internal combustion engines (ICEs) for propulsion. Energy consumption of an electric energy vehicle driving system may vary as operating conditions. For example, the electric energy consumption may be affected by speed, motor efficiency, load, and road condition. FIG. 5 shows a block diagram of an exemplary embodiment of a vehicle system for driving a plurality of wheels. The system includes an electric energy battery system 600 which is coupled to a control system 620 and a driving system 610. The control system 620 is provided and configured to control various components related to the vehicle system. In one example, the control system 620 includes a computer control system. The control system 620 further includes non-transitory, computer readable storage media (not shown) including code for enabling on-board monitoring and control of engine, motor, battery operation. The control system 620 may be configured to receive signals from a variety of sensors, as further elaborated herein, in order to determine operating parameters and operating conditions, and correspondingly adjust various actuators to control operation of the vehicle system. For example, the control system may receive signals from various sensors including, but not limited to, intake manifold temperature 118, engine, motor speed, engine, motor load, ambient pressure, etc. Correspondingly, the control system 620 may control the vehicle system by sending commands to various components such as motors, cylinder valves, throttle, heat exchangers, or other flow control elements, etc.

In some embodiments, the control system 620 may control the vehicle driving system 610, for example, engine, motor according to a control database which refers to a collection of at least partially interrelated data, usable for control purposes, and which may be stored electronically by the control system. In one example, the present invention includes the gyroscope (gyro) 630 which is coupled to an electric energy consumption prediction module 640. The electric energy consumption prediction module 640 is coupled to a consumption database 650. The consumption database 650 stores the relationship of electricity consumption parameter and the road condition. For example, the electric energy consumption rates with degree of a slope road, for example, the uphill, downhill road. The degree of the slope (gradient) will affect the electric energy consumption. The different degree of the uphill and downhill slop road involves the different electricity consumption rate. The consumption database 650 stores the parameters for the electric energy consumption prediction module 640 to predict how long the residual electric energy may be last or how far the vehicle may run under current road condition by the residual electric energy. The prediction may be refreshed when the road condition is changed. The gyroscope 630 is employed to detect the uphill or downhill road conditions, and followed by transmitting the detected information to the control system 620. The electric energy consumption prediction module 640 which is coupled to the control system 620 is responsive to the information detected by the gyroscope 630 to predict how long or how far (miles or kilometer) the vehicle may run by using the residual electricity energy in the battery based on the information in the consumption database 650 under current road conditions. The electric energy consumption prediction module 640 is employed to generate the prediction information for predicting a remaining travel distance of the vehicle by using the residual electric energy.

The predicted results may transmit to the control system 620, followed by displaying on the display 660 or/and generating a vocal message from the speaker 670. During engine or motor testing, for example, operating parameters may be determined and stored for each combination of engine, motor speed, load, road conditions. If the electricity is under a predetermined threshold, an electricity supply station database 700 coupled to the control system 620 may transmit the location of nearby electricity supply station to the map module 690 and displayed on the display based on the assistant of the navigator module 680 coupled to the control system 620. The gyroscope mentioned above is a device for measuring or maintaining orientation, based on the principles of angular momentum. It changes in response to an external torque much less and in a different direction than it would without the large angular momentum associated with the disc's high rate of spin and moment of inertia. Gyroscopes based on other operating principles also exist, such as the electronic, microchip-packaged MEMS gyroscope devices, solid-state ring lasers, fibre optic gyroscopes, and the extremely sensitive quantum gyroscope.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A vehicle comprising:
a control system;
an electric energy battery system coupled to said control system;
an electric energy consumption prediction module coupled to said control system;
a gyro coupled to said control system to detect a road condition, and transmitted said detected road condition to said control system; wherein said electric energy consumption prediction module is in responsive to said detected road condition to generate a predict information for predicting a remaining travel distance of said vehicle.

2. The vehicle of claim 1, further comprising a consumption database coupled to said electric energy consumption prediction module.

3. The vehicle of claim 2, wherein said consumption database includes a relationship between a road condition and an electric energy consumption.

4. The vehicle of claim 1, wherein said predicted information is displayed on a display.

5. The vehicle of claim 1, wherein said predicted information is transmitted to a speaker.

6. A vehicle comprising:
a control system;
an electric energy battery system coupled to said control system;
an electric energy consumption prediction module coupled to said control system;
a gyro coupled to said control system to detect a road condition, and transmitted said detected road condition to said control system; wherein said electric energy consumption prediction module is in responsive to said detected road condition to generate a predict information for predicting a remaining travel distance of said vehicle;
a navigator module coupled to said control system for measure geography information;
an electronic map module coupled to said control system to provide geography map; an electricity supply station database coupled to said control system to indicate an electric supply station in said electronic map by said navigator module.

7. The vehicle of claim 6, further comprising a consumption database coupled to said electric energy consumption prediction module.

8. The vehicle of claim 7, wherein said consumption database includes a relationship between a road condition and an electricity energy consumption.

9. The vehicle of claim 6, wherein said predicted information is displayed on a display.

10. The vehicle of claim 6, wherein said predicted information is transmitted to a speaker.

11. A vehicle comprising:
a control system;
an electric energy battery system coupled to said control system;
an electric energy consumption prediction module coupled to said control system;
a gyro coupled to said control system to detect a road condition, and transmitted said detected road condition to said control system;
wherein said electric energy consumption prediction module is in responsive to said detected road condition to generate a predict information for predicting a remaining travel distance of said vehicle;
a consumption database coupled to said electricity energy consumption prediction module; wherein said consumption database includes a relationship between a road condition and an electricity energy consumption.

12. The vehicle of claim 11, wherein said predicted information is displayed on a display.

13. The vehicle of claim 11, wherein said predicted information is transmitted to a speaker.

14. The vehicle of claim 11, a navigator module coupled to said control system for measure geography information, an electronic map module coupled to said control system to provide geography map; an electricity supply station database coupled to said control system.
